(19) United States
(12) Patent Application Publication
(10) Pub. No.: US 2016/0216238 A1
(43) Pub. Date: Jul. 28, 2016

(54) DEVICE AND METHOD FOR MONITORING AN OBJECT IN AN EXPLOSION-PROTECTED ZONE BY MEANS OF ULTRASOUND

(71) Applicant: FRAUNHOFER-GESELLSCHAFT ZUR FÖRDERUNG DER ANGEWANDTEN FORSCHUNG E.V., München (DE)

(72) Inventors: LARS SCHUBERT, Schoenteichen, OT Petershain (DE); THOMAS KLESSE, Dresden (DE); OLAF ROEDER, Dresden (DE); BERND FRANKENSTEIN, Ullersdorf (DE)

(21) Appl. No.: 14/913,421

(22) PCT Filed: Aug. 14, 2014
(86) PCT No.: PCT/EP2014/002244

§ 371 Date: Feb. 22, 2016

(30) Foreign Application Priority Data
Aug. 22, 2013 (DE) 10 2013 014 067.6
Dec. 13, 2013 (DE) 10 2013 020 896.3

(51) Int. Cl. G01N 29/14

(52) U.S. Cl. CPC G01N 29/14

(57) ABSTRACT

The present invention relates to a device and related method that includes an ultrasonic transducer, an acoustic waveguide acoustically coupled to the ultrasonic transducer and transmitting and receiving electronics for transmitting and receiving ultrasound waves via the ultrasonic transducer in an explosion-protected housing. The transmitting and receiving electronics has an energy storage connected to an amplifier circuit, wherein control signals for the ultrasonic transducer transmitted from outside can be amplified to such an extent that ultrasonic signals significantly strong for monitoring can be generated. By means of the acoustic waveguide, the ultrasonic signals are guided outside through an explosion-protected passthrough in the housing and are coupled into the object. As a result, objects can be continuously monitored in explosion-protected zones without violating the safety regulations and without a stoppage of the associated system or draining of the objects.

### TECHNICAL FIELD

The present invention relates to a device and method for monitoring an object in an explosion-protected zone in which an ultrasonic transducer, an acoustic waveguide acoustically coupled with the ultrasonic transducer and a transmitting and receiving electronics for transmitting and receiving ultrasonic signals through the ultrasonic transducer are used.

Regulations and measures for explosion protection, hereinafter referred to as explosion protection, are extremely important, not only in power plants, fuel depots and the chemical industry but also in the manufacturing sector. To minimise risk of explosion caused by technical equipment in hazardous locations, explosion-proof zones or areas are set up, in which strict safety regulations are imposed. In general, the question of explosion-protection is regulated by laws such as the ATEX directives of the European Union or the National Electrical Code (NEC) in the US.

Besides complying with the statutory safety regulations in explosion-protected zones, it is also imperative to monitor the equipment located in such explosion-protected zones regularly.

### PRIOR ART

Various methods of nondestructive testing, such as ultrasonic pulse echo, radiography or magnetic powder penetration, are known for monitoring objects or equipment in explosion-protected areas and are conducted periodically. However, in order to conduct the test, the sensor and the test equipment have to be brought to the test object and activities have to be carried out at the test object. This is often associated with downtime and occasional outage (production stoppage) of the technical installation. When testing liquid or gas-filled tanks or pipelines, depending on the test procedure implemented it may also be necessary to empty the tanks or pipelines before the test.

For monitoring pressure equipment during operation, the technique of acoustic emission testing (AE: Acoustic Emission) is known. In this procedure, the system does not have to be drained, or production stopped. The corresponding sensors are designed to function in ex-protected zones, and attached to the object to be measured. Acoustic waves as they occur in the metallic pressure equipment when the equipment is exposed to bending, pressure or tension are converted via an acoustic transducer in the sensor into electrical signals, which are analysed for monitoring the equipment. However acoustic emissions are only created as a result of changing pressure loads or active corrosion processes. Systems under quasi-static load cannot be verified in this way because the AE test only detects crack growth, not the presence of cracks.

The use of ultrasonic inspection methods in which ultrasound is actively coupled into the objects to be able to detect cracks on the basis of ultrasonic echoes requires very high transmission power to obtain a reliable measurement. The associated high transmission voltages and currents are prohibited in explosion-protected areas. Consequently, ultrasound techniques have previously only been used for level monitoring and distance measurement in safety-critical areas because these applications do not require high transmission power.

EP 2 541 541 A1 discloses an arrangement for nondestructive monitoring or testing components by means of sound wave analysis in which at least one waveguide is attached to the component with a tensioning device so that it rests flat on the component.

From U.S. Pat. No. 5,257,530 A, an apparatus is known for the acoustic detection of sand in a line through which a liquid flows, in which a sensor and a preamplifier are accommodated in an explosion-proof housing.

DE 195 38 678 A1 discloses an arrangement for level monitoring by means of an ultrasonic sensor, in which the piezoelectric transducer is housed in a housing, and is encapsulated with a casting compound together with the associated circuit board for the purpose of explosion protection.

The object of the present invention is to provide an apparatus and method for monitoring objects in explosion-protected areas which also allow the monitoring continuously while the respective object or the corresponding facility are operating, without stoppage of the facility, and can also detect cracks or other local defects in objects with quasi-static load.

### SUMMARY OF THE INVENTION

The object is achieved with the device and method according to claims 1 and 6. Advantageous embodiments of the apparatus and the method are the subject of dependent patent claims or will be made evident in the following description and the exemplary embodiments.

The suggested device for monitoring an object in an explosion-protected area at least comprises an ultrasonic transducer, an acoustic waveguide acoustically coupled with the ultrasonic transducer and a transmitting and receiving electronics for transmitting and receiving ultrasonic signals via the ultrasonic transducer in an explosion-protected housing. The acoustic waveguide extends outwards through an explosion-protected passthrough in the housing so that it can be acoustically coupled to the object to be monitored. The transmitting and receiving electronics has an energy storage and an amplifier circuit connected to the energy storage for incoming control signals for the ultrasonic transducer. The transmitting and receiving electronics is preferably connected to at least one explosion-protected electrical connector wire that passes through to the outside through another explosion-protected passthrough in the housing. This electrical connector wire is used to transmit the control signals for the ultrasonic transducer from outside the housing and can be connected to an external control device. In general, the control signals and the received signals converted by the ultrasonic transducer can also be transmitted between the control device and the transmitting and receiving electronics wirelessly as well.

In the suggested method for monitoring an object in an explosion-protected area, the acoustic waveguide which is acoustically coupled with the ultrasonic transducer is coupled with its open end located outside the housing to the object to be monitored. The ultrasonic transducer is actuated to emit ultrasonic signals from the outside via the explosion-protected electrical connecting line and the transmitting and receiving electronics. Some of the electrical energy required to excite the ultrasonic transducer for monitoring of the object is provided by the energy storage of the transmitting and receiving electronics. The ultrasonic waves or ultrasonic signals are coupled into the object by the ultrasonic transducer through the acoustic waveguide, wherein a portion of the ultrasound waves reflected in the object passes back to the ultrasonic transducer through the acoustic waveguide and is converted into electrical signals thereby. The signals that are reflected and converted by the ultrasonic transducer may then be used in known manner to provide information about local faults or cracks in the object. The electrical signals can be at least partially processed or already further processed in the transmitting and receiving electronics before they are forwarded to the control device via the electrical connecting line used for the control signals or via another explosion-protected electrical connecting line. It is also possible to directly transmit the electrical signals to the control device via the transmitting and receiving electronics and the electrical connecting line used for the control signals or another explosion-protected electrical connecting line.

The proposed device and the associated method enable permanent monitoring of objects or facilities using ultrasound technology, without the need for a plant shutdown or—in the event of filled containers or pipes, for example—without having to have the objects emptied for testing. And the device can also be installed permanently on the objects to be monitored. In this respect, a portion of the high output power of the ultrasonic transducer needed to operate the device and detect very small defects, particularly in large objects to be tested, is provided by the energy storage and the associated amplifier circuit arranged in the explosion-protected housing. Thus, high transmission voltages and/or currents can be generated without having to transmit them via the electrical connection line. The electrical power that is transmitted over the electric connection is selected so that it falls within the safety limits prescribed for explosion-protected areas. Since the required extra energy is supplied in the explosion-protected housing İtself, the device satisfies these safety requirements, enables permanent monitoring of objects with no system downtime and provides sufficient ultrasound transmission power to reliably detect even small defects or cracks in the steady state of the objects.

The method and device can be used to perform more than just ultrasound tests. Acoustic emissions from the objects can also be tested using acoustic examination (AE) by analysing the sound waves that pass through the acoustic waveguide from the object to the ultrasonic transducer and are converted into electrical signals by the ultrasonic transducer. This can be done, for example, during the transmission pauses of said ultrasonic transducer. With the suggested method by using ultrasonic examination cracks in the objects can exposed to the sound, and their reflection and transmission properties can be used for fault localization largely independently of the load condition of the object or facility. The fault echoes are higher if higher transmission voltages and currents and consequently higher transmission energies can be used. Whereas previously known AE sensors are limited to 20 μJ-160 μJ for acoustic emission testing due to their intrinsically safe design and maximum allowable energy, the proposed device or sensor that is realized with the proposed device enables the use of considerably higher transmission energies in the explosion-protected areas. Damage detection can be carried out directly using the AE process and/or through the use of ultrasonic testing by sending and receiving ultrasonic signals (AU: Acousto-Ultrasonic) even after a crack has formed. This prevents the objects from suffering subsequent damage and thus reduces the operational and cost risks for the operators.

The acoustic waveguide is preferably chosen such that the ultrasonic signals are transmitted into the object substantially without dispersion. This can be achieved, for example, with an acoustic waveguide that has a rod-shaped, cylindrical geometry over most of its length. In order to couple ultrasonic signals from the ultrasonic transducer into the acoustic waveguide, a funnel-shaped geometry of the acoustic waveguide at the interface between acoustic waveguide and ultrasonic transducers may be used. The use of a substantially rod-shaped acoustic waveguide has the further advantage that commercially available explosion-protected housings with correspondingly designed explosion-protected bushings can be used, which are typically designed for the passage of cables. The rod-shaped geometry of the acoustic waveguide also renders these bushings suitable for the acoustic waveguide.

The energy storage provided in the explosion-protected housing as part of the transmitting and receiving electronics accumulates electric energy for the operation of the ultrasonic transducer at a sufficiently high transmission power. The electrical energy can be supplied to the energy storage from outside, particularly via the explosion-protected electrical connection line. The energy storage accumulates this supplied energy so that it is able to provide sufficient power for an ultrasonic transducer actuated in intervals. Electrical energy storages such as capacitors or accumulators or also chemical storage devices (such as fuel cells) may be used.

In a preferred embodiment, the energy required for ultrasound generation and/or to power the electronics may be drawn additionally or exclusively by energy conversion from the environment outside the housing. To this end, a power transducer is electrically connected to the energy storage, and converts this energy from the environment into electrical energy for the energy storage. In this case, the power transducer can be located inside or outside of the housing. In one embodiment, the energy transducer is designed as an electromechanical transducer, for example, which converts vibrations and/or changes in the potential energy and/or pressure changes into electrical energy.

In another embodiment, the energy transducer is designed such that it converts electromagnetic, particularly optical radiation into electrical energy. For this purpose the explosion-protected housing preferably is at least partially translucent or generally permits the passage of a part of the electromagnetic spectrum, so that the power transducer can be arranged in the explosion-protected housing.

In a further embodiment, the energy transducer is designed to convert thermal energy into electrical energy. In this case, the energy transducer may convert temperature differences into electrical energy. For this purpose, the explosion-protected housing may be designed for specific heat conduction, e.g., by material pairings, which have a selectively heat conducting and heat insulating effect.

The energy generated by the transducer and/or transmitted via the electrical connecting line is stored or accumulated for a period by the energy storage. If enough energy is stored and/or after a predetermined period and/or after detection of an acoustic signal from the object to be monitored or due to some other event, the transmitting and receiving electronics in the housing generates a powerful electric actuating signal for the ultrasound transducer.

When the device is in use or the proposed method is being carried out, the acoustic waveguide is acoustically coupled to the object to be monitored. This can be done by material bonding, by force-locked join or by form-locked join. Thus, the acoustic waveguide may be attached to the object by soldering, welding and/or gluing, for example.

Through the use of the proposed device and the associated method, facilities or objects of facilities such as pressure vessels, pipelines and the like can be monitored while they are in use and operation, largely without consideration for their filling level. If the device is permanently attached to the objects to be monitored, a Structural Health Monitoring (SHM) system based on the excitation and/or reception of ultrasonic waves can be created, with permanent monitoring of the facility and with no facility downtime. With the method and the device, besides crack detection or detection of other defects, a wall thickness determination of objects in explosion-protected areas can be carried out. For example, the method and device can be used to monitor hazardous material containers, tanks and pipelines for oil, gas and solvents, grain, flour and food stores, etc. or storage tanks for chemicals, powders, and the like.

### BRIEF DESCRIPTION OF DRAWINGS

The proposed method and the associated device will be explained again in greater detail in the following with reference to embodiments thereof and in conjunction with the drawings. In the drawings

FIG. 1 is a schematic representation of an embodiment of the suggested device and the associated method;

FIG. 2 is a cross-sectional view of an embodiment of the suggested device; and

FIG. 3 is a block diagram of a variant of the transmitting and receiving electronics of the suggested device.

### WAYS OF IMPLEMENTING THE INVENTION

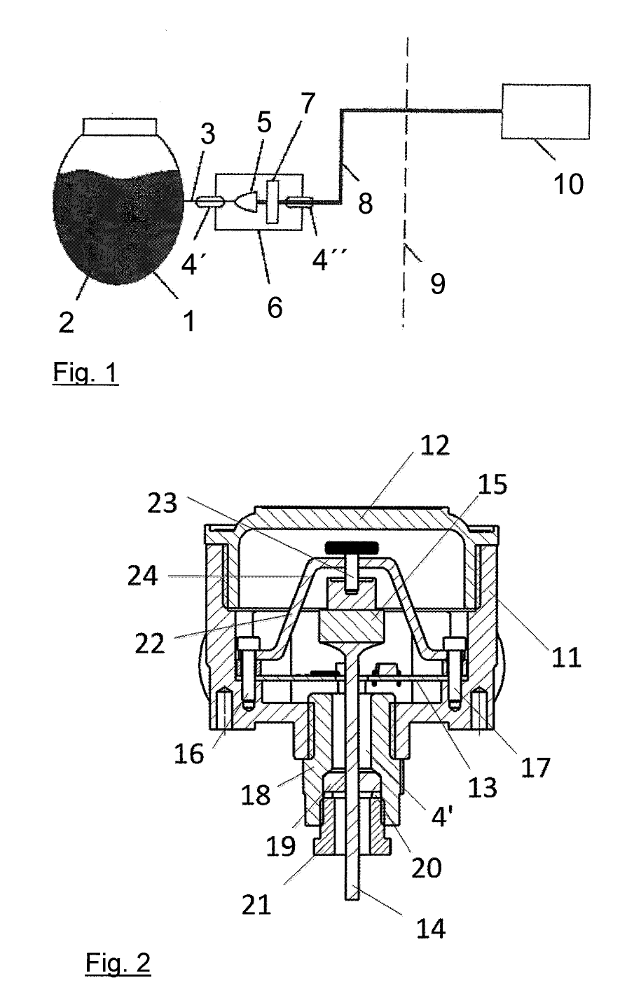

FIG. 1 is a schematic representation of the proposed device. The device comprises an ultrasonic transducer 5, to which a substantially rod-like acoustic waveguide 3 is acoustically coupled. Ultrasonic transducer 5, which functions as an ultrasonic sensor and actuator, is operated by a transmitting and receiving electronics 7. Ultrasonic transducer 5 and transmitting and receiving electronics 7 are arranged in an explosion-protected housing 6, which has appropriate explosion protection, such as Ex-e, Ex-d, Ex-m, Ex-q or Ex-o. Such housings also have explosion-protected cable passthroughs 4′, 4″. One of the two cable passthroughs 4′ is used for the acoustic waveguide 3 to pass through the explosion-protected housing 6 to the outside. The end of this acoustic waveguide 3 that is outside housing 6 is welded to the surface of object 1 to be monitored, in this example a tank filled with a liquid 2. Acoustic waveguide 3 is used for the transmission of the ultrasound from ultrasonic transducer 5 into object 1 and from the object 1 back to ultrasound transducer 5.

Transmitting and receiving electronics 7 is connected via an electrical connecting line 8 which passes through the second explosion-protected passthrough 4″ to a control device 10 which houses the control and analysis electronics. The separation of the explosion-protected area from the safe region is indicated by dotted line 9. Control device 10 generates a transmission signal for ultrasonic transducer 5 with a transmission voltage and transmission current and thus transmission energy that is limited to the maximum permissible values of 20 μJ to 160 μJ in accordance with EN 60079-11 and the applicable zone. The transmitting and receiving electronics 7 integrated in housing 6 is equipped with an energy storage, e.g., in the form of electrical capacitors, which accumulates the energy transmitted from the control device 10 with the signal over a time interval. From this energy, a powerful ultrasonic signal with high transmission voltages, and currents, and consequently high power output, is generated by ultrasonic transducer 5 in the pressure-resistant housing 6. The transmitted signal can be processed and the signal received by the ultrasonic transducer can be amplified by the integrated transmitting and receiving electronics 7.

When such a device is operated, a transmission signal complying with the explosion protection requirements with small, permissible energies is thus generated in control device 10 and transmitted via electrical connection line 8 to transmitting and receiving electronics 7 inside explosion-protected housing 6. The energy storage in the integrated transmitting and receiving electronics 7 accumulates the transmission energy supplied thereby and amplifies the transmission signal to actuate the ultrasonic transducer 5, so that it generates an ultrasonic wave suitable for material testing. Acoustic waveguide 3 is connected in form-locked manner to object 1 to be monitored, guides the ultrasonic wave out of housing 6 and transmits it to the object 1. Ultrasonic waves reflected in object 1 by defects such as cracks return partly to the ultrasound transducer 5 via the acoustic waveguide 3 and are converted by the transducer into an electrical reception signal. This reception signal is transmitted via transmitting and receiving electronics 7 and electrical connection line 8 back to control device 10 where it is analysed. This analysis enables conclusions to be drawn directly regarding the presence or emergence of a fault in the object.

It is also possible to store the respective received signals or the variables derived therefrom as values in the control device. A comparison value can then be formed for monitoring purposes from the values stored at one or more selected points in time and the values stored at other points in time. By comparing this comparison value with a suitably selected threshold value, an alarm may be triggered depending on the result of the comparison, indicating the emergence of a defect with critical implications for the operation.

FIG. 2 shows a cross-sectional view of a possible variant of the explosion-protected housing and the components housed therein. The housing in this example is made from a pressure housing 11 with a pressure cover 12, made from the material SB26. This certified Ex-d enclosure accommodates ultrasonic transducer 15, which couples an acoustic waveguide 14 which is funnel-shaped in the transition area to the ultrasonic transducer 15, via a ceramic electrical insulation disc—not shown in the figure. The acoustic waveguide 14 is made of stainless steel and the cylindrical rod-like part thereof, which adjoins the funnel-shaped portion, has a diameter of 1 mm to 10 mm, preferably 4 mm. The funnel-shaped part of the acoustic waveguide 14, which is connected to the ceramic disc of the ultrasound transducer 15, thereby tapers over a length of 1 mm to 10 mm, preferably 4 mm, from the diameter of the ultrasonic transducer (diameter 10 mm to 40 mm, preferably 20 mm) to the diameter of the steel rod of preferably 4 mm. The housing 11, 12 has two certified Ex-d cable or conduit entries 4′ and 4″, one of which 4′ appears İn FIG. 2. One of these cables enables the feed of an electrical connection cable for controlling the sensor technology. The other serves to allow the rod-shaped acoustic waveguide 4′ to pass through which is spot-welded directly to the object to be monitored. FIG. 2 shows a seal bushing 18, a sealing insert 19, a gasket pressurizing ring 20 and a packing nut 21 that form this Ex-protected passthrough 4″. The electrical connection cable (not shown) is routed to the control device of the device. İt is important that the connection of the free cable end of this connecting cable is outside of the explosion-protected area.

FIG. 2 shows further details of housing 11, 12 and the components arranged therein such as a printed circuit board with the transmitting and receiving electronics, three screws 16, 17, 23 a stay 22 and a bumper 24 for the ultrasonic transducer 15.

The cover of the housing is fixed with grub screws and preferably sealed so that the housing cannot be opened without tools and any attempt to open is evident. By accommodating the electronic components including the preferably piezoelectric ultrasonic transducer connected to the waveguide in an Ex-d standard housing the proposed device can be used in explosion-protected areas. The possibility of using a standard housing eliminates the time-consuming and expensive development and production of an explosion-protected extra housing for this application. This is achieved mainly through the use of a waveguide having a rod-like cylindrical shape in the area of the passthrough which waveguide can use the prefabricated explosion-protected passthroughs for cable in such a standard housing to ensure coupling with almost no dispersion. By accommodating the components needed for AU and AE measurements in the prefabricated housing, combining the two methods of measurement is possible in a compact housing.

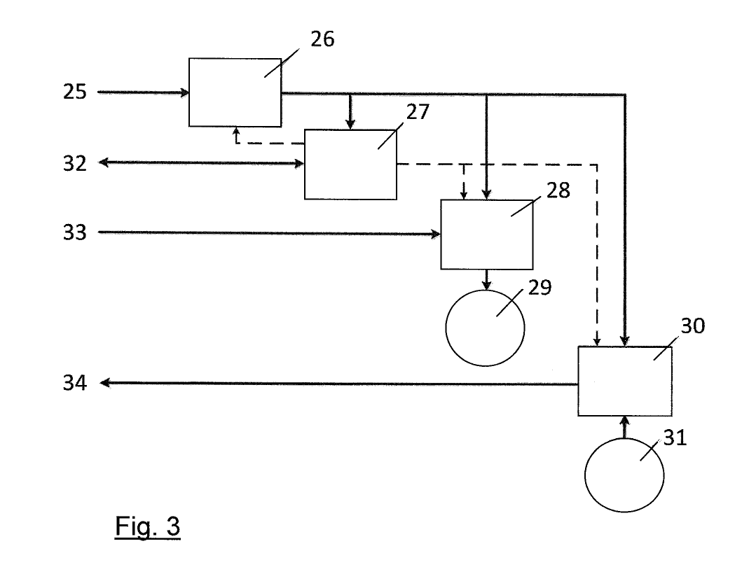

Finally FIG. 3 shows a schematic representation of an example of a configuration of the transmitting and receiving electronics with the energy storage circuit and the amplifier in an explosion proof housing.

Power is supplied via supply line 25. İn the subsequent energy storage 26, energy is intermediately buffered as previously described. İn this example a control computer 27, the transmitter electronics 28 with integrated amplifier and the receiver electronics 30 are connected to the energy storage 26. The receiver electronics 30 is connected to sensor 31, the transmitter electronics 28 is connected to actuator 29 wherein this—as shown here—can be constructed separately from the sensor 31 or also conjointly with the sensor 31. The electrical connection cable 8 to the explosion-protected housing in this example besides the supply line 25 also contains the data line 32 to communicate with the control computer 27, the transmission signal line 33 to transmit the actuator signal and the receiving signal line 34. This transfers the reception signal, recorded by the sensor 31 and then amplified and processed further in the receiver electronics 30 to the safe area.

In the present patent application the object is understood to be the object to be monitored. This can be for example a hazardous material container/reactor for storage or processing of oil, gas or solvents or other substances, or a pipeline or connected pipes for transporting substances, for example cereals, flour or other foods, for example, and particularly for the dust thereof, or storage tanks for chemicals, powder, etc.

The explosion-protected area is understood to be a part of a space or a space that is subject to regulations by standards for explosion protection, for example the ATEX directives and guidelines of the European Union and/or the National Electrical Code (NEC) in the USA.

An explosion-protected housing is understood to be an enclosure that allows standard-compliant encapsulation of a non-standard interior. Standard-compliant means compliant with the current standards valid for the application.

An explosion-protected passthrough is understood to be an element introduced into a housing opening of an explosion-protected housing, through which a transmission element, in particular for electrical and/or acoustic signals, passes through from inside to outside, without interrupting the standard-compliant encapsulation of the housing.

An ultrasonic transducer is a bidirectional electromechanical transducer for transmitting and receiving acoustic signals, at least in the ultrasonic range.

### LIST OF REFERENCE NUMBERS

1 Object
2 Liquid
3 Acoustic waveguide
4′ Ex-protected passthrough
4″ Ex-protected passthrough
5 Ultrasonic transducer
6 Ex-proof housing
7 Transmitting and receiving electronics
8 Electrical connection line
9 Area limit
10 Control device
11 Pressure housing
12 Pressure cover
13 Printed circuit board
14 Acoustic waveguide
15 Ultrasonic transducer
16 Screw
17 Screw
18 Seal bushing
19 Sealing insert
20 Seal pressure ring
21 Sealing nut
22 Stay
23 Screw
24 Bumper stop
25 Supply line for power supply
26 Energy storage
27 Control computer
28 Transmitter electronics
29 Actuator
30 Receiver electronics
31 Sensor
32 Data line
33 Transmission signal line
34 Receiving signal line

1. A device for monitoring an object in an explosion-protected zone by means of ultrasound, which comprises at least
an ultrasonic transducer,
an acoustic waveguide acoustically coupled with the ultrasonic transducer (5) and
a transmitting and receiving electronics for sending and receiving ultrasonic signals via the ultrasonic transducer in an explosion-protected housing,
wherein the transmitting and receiving electronics has an energy storage and an amplifier circuit, connected to the energy storage, for incoming control signals for the ultrasonic transducer (5), and the acoustic waveguide protrudes through an explosion-protected passthrough in the housing to the outside so that it can be acoustically coupled to the object.

2. The device according to claim 1, characterized in that the transmitting and receiving electronics can be connected to an external control device via at least one explosion-protected electrical connection line, which is routed to the outside by means of a further explosion-protected passthrough in the housing, for transferring the control signals for the ultrasonic transducer.

3. The device according to claim 1, characterized in that over the major part of its longitudinal extension the acoustic waveguide has a rod-shaped cylindrical geometry.

4. The device according to claim 1, characterized in that the transmitting and receiving electronics is designed such that it can excite the ultrasonic transducer with an electrical power of >160 μJ to emit ultrasonic signals.

5. The device according to claim 1, characterized in that the energy storage is connected to an energy transducer that converts mechanical and/or thermal and/or electromagnetic energy into electrical energy.

6. A method for monitoring an object in an explosion-protected zone by means of ultrasound using a device in accordance with claim 1, in which
the acoustic waveguide acoustically coupled to the ultrasonic transducer is acoustically coupled at its opposite end to the object to be monitored,
the ultrasonic transducer is activated via the transmitting and receiving electronics to emit ultrasonic signals, wherein a proportion of the electrical energy required for the excitation of the ultrasonic transducer for monitoring is provided from the energy storage of the transmitting and receiving electronics,
ultrasonic waves from the ultrasonic transducer are coupled via the acoustic waveguide into the object, and
a proportion of the ultrasound waves reflected by or in the object passes back to the ultrasonic transducer via the acoustic waveguide and is converted into electrical signals by the ultrasonic transducer.

7. The method according to claim 6, characterized in that at least 50% of the electrical energy required for the excitation of the ultrasonic transducer for monitoring is provided from the energy storage of the transmitting and receiving electronics.

8. The method according to claim 6, characterized in that the acoustic waveguide is connected to the object via a material connection, or a force-locked join or a form-locked join.

9. The method according to claim 6, characterized in that the energy storage accumulates electrical energy of an energy source located outside of the housing.

10. The method according to claim 6, characterized in that an energy transducer electrically connected to the energy storage converts mechanical and/or thermal and/or electromagnetic energy into electrical energy and the energy storage accumulates the electrical energy provided by the energy transducer.

11. The method according to claim 6, characterized in that the electrical signals of the ultrasonic transducer are transmitted either unchanged or after a processing step in the transmitting and receiving electronics to a control device arranged outside of the explosion-protected zone for evaluation.

12. The method according to claim 11, characterized in that acoustic waves emitted by the object also pass back to the ultrasonic transducer via the acoustic waveguide and are converted into electrical signals by the ultrasonic transducer.

13. The method according to claim 11, characterized in that the electrical signals of the ultrasonic transducer or variables derived therefrom are stored as values.

14. The method according to claim 13, characterized in that from the values stored at a point in time or at selected points in time and the values stored at other points in time, a comparison value is formed.

15. The method according to claim 14, characterized in that the comparison value is compared with a threshold value and depending on the result of the comparison an alarm is triggered.
